(19) United States
(12) Patent Application Publication
(10) Pub. No.: US 2026/0212721 A1
(43) Pub. Date: Jul. 23, 2026

(54) METHOD AND SYSTEM FOR DETERMINING VALIDITY OR INVALIDITY OF A BALLOT USING AN RFID TAG

(71) Applicant: RFCAMP LTD., Anyang-si (KR)

(72) Inventor: Joo Young RYU, Seongnam-si (KR)

(21) Appl. No.: 19/170,783

(22) Filed: Apr. 4, 2025

(30) Foreign Application Priority Data
Jan. 23, 2025 (KR) 10-2025-0010714

(51) Int. Cl. G07C 13/02; G06K 19/04

(52) U.S. Cl. CPC G07C 13/02; G06K 19/045

(57) ABSTRACT

A method for classifying invalid ballots using values recorded in an RFID tag embedded in a ballot includes: receiving, by a reader, an insertion signal from a sensor located at a slot of a first ballot box, indicating that a first ballot is being inserted; transmitting, by the reader, a write request signal to store a predetermined value in a first RFID tag embedded in the first ballot; identifying, by the reader, the first RFID tag upon arrival at a counting station and requesting and obtaining a value recorded in a predetermined data block of the first RFID tag; and determining, by the reader, whether the recorded value is within a predefined valid range, and if the recorded value falls outside the valid range, classifying the first ballot with the first RFID tag as an invalid ballot.

### CROSS-REFERENCE TO RELATED APPLICATION

This application is based on and claims priority under 35 U.S.C. §119 to Korean Patent Application No. 10-2025-0010714, filed on January 23, 2025, in the Korean Intellectual Property Office, the disclosure of which is incorporated by reference herein in its entirety.

### BACKGROUND

### 1. Field

Embodiments of the present disclosure relate to a method and system for classifying invalid ballots in a ballot box using a value recorded in an RFID tag, characterized in that the method includes recording predetermined data in a memory of the RFID tag at the time of entry into the ballot box, and using the data recorded on the ballot at a counting station to determine whether the ballot is a spoiled ballot.

### 2. Description of the Related Art

Elections, the formal process by which a people or a group of people choose their representatives, is a system used in democratic countries. It is an important process that determines major policies and leaders.

Voting is the act of expressing one's will in an election, indicating one's favor or opposition to a particular candidate or policy. Voters visit a polling station, identify themselves, receive a ballot, select the options they want on the ballot, and drop it in the ballot box.

When it comes to voting, there is an early voting system that can be used outside of Election Day. Early voting refers to the ability to vote at early voting locations that are set up during the early voting period, allowing voters to exercise their right to vote by visiting an early voting location other than their own address.

At the end of election hours, the ballot boxes containing the ballots are transported to their respective counting centers to be counted. Because of this time lag between voting, early voting, and counting, it is possible for ballots to be mixed with fraudulent ballots other than those marked by the voter.

As a result, there is a need to monitor ballot boxes for fraudulent ballots and determine which ballots are invalid.

### SUMMARY

The disclosure has been devised to solve the above technical problem and provides a system, method, and computer program for determining the validity of a ballot by utilizing the information stored in the RFID tag embedded in the ballot.

Additionally, the disclosure has been devised to solve the above technical problem and provides a system, method, and computer program for determining whether a ballot was cast at a valid location and/or within a valid time frame by utilizing the information stored in the RFID tag embedded in the ballot.

Moreover, the disclosure has been devised to solve the above technical problem and provides a system, method, and computer program for generating time-series data for ballots inserted into the ballot box and determine the validity of the ballots using the time-series data.

However, such a technical problem is an example, and the objective of disclosure to solve is not limited thereto.

Additional aspects will be set forth in part in the description which follows and, in part, will be apparent from the description, or may be learned by practice of the presented embodiments of the disclosure.

According to one or more embodiments, a method may include receiving, by a reader, an insertion signal from a sensor located at a slot of a first ballot box, indicating that a first ballot is being inserted; transmitting, by a reader, a write request signal to store a predetermined value in a first RFID tag embedded in the first ballot; identifying, by a reader, the first RFID tag upon arrival at the ballot counting station and requesting and acquiring, by a reader, the value recorded in a predetermined data block of the first RFID tag; and determining, by a reader, whether the recorded value is within a predefined valid range, and if the recorded value falls outside the valid range, and classifying the first ballot with the first RFID tag as an invalid ballot.

The transmitting the write request signal may include sending a write request signal to record at least one of a location value or a time value obtained through a GPS sensor in the data block.

The transmitting the write request signal may further include transmitting a signal to the first RFID tag to set the data block to a write-locked state(write-protected state) after sending the write request signal.

The requesting and acquiring the value may include receiving a signal requesting an access password from the first RFID tag, and the reader transmitting a pre-stored access password to the first RFID tag.

The transmitting the write request signal may include encrypting at least one of the location value or the time value obtained through the GPS sensor using a predetermined encryption method and transmitting a write request signal to record the encrypted data in the data block.

The method may further include separately storing, by the reader, the time value at which the first ballot was inserted into an EPC or user memory; and generating and storing time-series data on the number of ballots inserted within a predefined time interval.

According to embodiments of the present disclosure, a system may include a first communicator, a second communicator, a memory, and a processor. The processor may receive an insertion signal from a sensor located at the inlet of a first ballot box via the second communicator, indicating that a first ballot is being inserted; transmit a write request signal to store a predetermined value in a first RFID tag embedded in the first ballot; identify the first RFID tag upon arrival at the ballot counting station and request and acquire the value recorded in a predetermined data block of the first RFID tag; determine whether the recorded value is within a predefined valid range; and if the recorded value falls outside the valid range, sort and record the first ballot with the first RFID tag as an invalid ballot.

The processor may transmit a write request signal to record at least one of a location value or a time value obtained through a GPS sensor in the data block.

The processor may transmit a signal to the first RFID tag to set the data block to write-locked state(write-protected state) after transmitting the write request signal.

The processor may receive a signal requesting an access password from the first RFID tag and transmit a pre-stored access password to the first RFID tag.

The processor may encrypt at least one of the location value or the time value obtained through the GPS sensor using a predetermined encryption method and transmit a write request signal to record the encrypted data in the data block.

The processor may also separately store the time value at which the first ballot was inserted into an EPC or user memory; and generate and store time-series data on the number of ballots inserted within a predefined time interval.

According to an embodiment of the present disclosure, a computer program may be stored in a medium to execute any of the methods described in this specification using a computer.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an example of a ballot embedded with an RFID tag according to embodiments of the present disclosure.

FIG. 2 is a block diagram of an RFID tag, and FIG. 3 is a block diagram of the memory structure of an RFID tag.

FIG. 4 illustrates the process in which an RFID-tagged ballot is inserted into a ballot box.

FIG. 5 provides an example of a ballot box according to embodiments of the present disclosure.

FIG. 6 is a block diagram of a ballot box according to embodiments of the present disclosure.

FIG. 7 illustrates the method of communication with ballots stacked inside a ballot box.

FIG. 8 is a flowchart of the process for recording data onto an RFID tag embedded in a ballot according to embodiments of the present disclosure.

FIG. 9 is a flowchart of a method for classifying invalid ballots according to embodiments of the present disclosure.

FIG. 10 is a flowchart of an alternative method for classifying invalid ballots according to embodiments of the present disclosure.

FIG. 11 is a flowchart of a method for determining whether a ballot is invalid according to embodiments of the present disclosure.

FIG. 12 is a flowchart of a method for generating time-series data and final data according to embodiments of the present disclosure.

### DETAILED DESCRIPTION

Reference will now be made in detail to embodiments, examples of which are illustrated in the accompanying drawings, wherein like reference numerals refer to like elements throughout. In this regard, the embodiments of the present disclosure may have different forms and should not be construed as being limited to the descriptions set forth herein. Accordingly, the embodiments are merely described below, by referring to the figures, to explain aspects of the present description. As used herein, the term "and/or" includes any and all combinations of one or more of the associated listed items. Expressions such as "at least one of," when preceding a list of elements, modify the entire list of elements and do not modify the individual elements of the list.

The disclosure may have various modifications and various embodiments, and specific embodiments are illustrated in the drawings and are described in detail in the detailed description. However, this is not intended to limit the disclosure to particular embodiments, and it will be understood that all changes, equivalents, and substitutes that do not depart from the spirit and technical scope of the disclosure are encompassed in the disclosure. In the description of the disclosure, even though elements are illustrated in other embodiments, like reference numerals are used to refer to like elements.

Hereinafter, embodiments of the disclosure will be described in detail with reference to the accompanying drawings, and in the following description with reference to the drawings, like reference numerals refer to like elements and redundant descriptions thereof will be omitted.

Although the terms "first," "second," etc. may be used to describe various elements, these elements should not be limited by these terms. These terms are only used to distinguish one element from another.

An expression used in the singular encompasses the expression of the plural, unless it has a clearly different meaning in the context.

It will be understood that the terms "comprise," "comprising," "include" and/or "including" as used herein specify the presence of stated features or elements but do not preclude the addition of one or more other features or elements.

Sizes of elements in the drawings may be exaggerated or reduced for convenience of explanation. In other words, because sizes and thicknesses of elements in the drawings are arbitrarily illustrated for convenience of explanation, the disclosure is not necessarily limited thereto.

The x-axis, the y-axis and the z-axis are not limited to three axes of the rectangular coordinate system, and may be interpreted in a broader sense. For example, the x axis, the y axis, and the z axis may be perpendicular to one another or may represent different directions that are not perpendicular to one another.

In the case where a certain embodiment may be implemented differently, a specific process order may be performed in the order different from the described order. As an example, two processes that are successively described may be substantially simultaneously performed or performed in the order opposite to the order described.

The terms used herein are only used to describe particular embodiments and are not intended to limit the scope of the disclosure. It will be understood that the terms "comprise," "comprising," "include" and/or "including" as used herein specify the presence of stated features, numbers, steps, operations, elements, parts, and combinations thereof, but do not preclude in advance the presence or addition of one or more other features, numbers, steps, operations, elements, parts, combinations thereof.

According to an embodiment of the disclosure, the phrase "recorded on the ballot" refers to data stored in the memory of an RFID tag embedded in or attached to the ballot, rather than printed on the paper ballot.

According to an embodiment of the disclosure, the RFID tag embedded in the ballot may either be integrated into the ballot itself or affixed to the ballot.

An "invalid time value" refers to a time that falls outside a predefined valid time range, which corresponds to the predetermined voting period.

An "invalid location value" refers to a location that falls outside a predefined valid range, which is determined based on designated voting locations across the country. The valid range for location values may be determined based on the positions of pre-established polling stations.

In the following embodiments, an "entry signal" may be interchangeable with an "insertion signal."

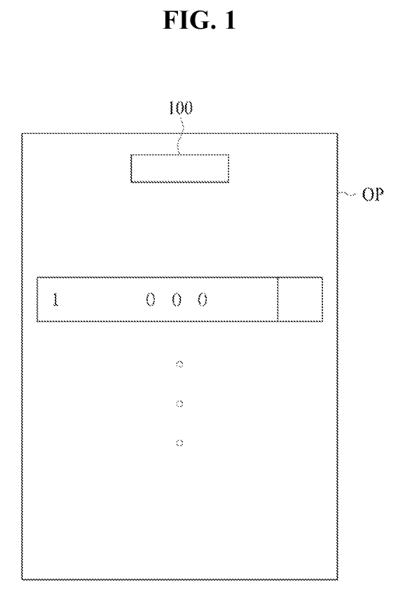

FIG. 1 illustrates an example of a ballot embedded with an RFID tag according to embodiments of the present disclosure.

According to embodiments of the present disclosure, a ballot OP includes an RFID tag 100 embedded in a specific area of the ballot. The RFID tag 100 may be an RFID label tag, which contains a unique tag identifier code TID. The TID is stored in a non-modifiable memory area. The RFID tag may include various memory areas such as the TID, EPC, and user memory. While the EPC and user memory are writable, the TID is a read-only section.

The RFID tag 100 may be embedded in the ballot using a wet inlay method and may be of the UHF ISO18000-6-C type or the 13.56 MHz ISO 14443A type. The RFID tag 100 may be attached as a sticker on the ballot and preferably measures 25mm × 25mm or 29mm × 13mm, though these dimensions are not limiting. The RFID tag 100 consists of an RFID module and an antenna, designed to be thin and flexible.

The RFID tag 100 may store a time value YYMMDDHHMMSS and a location value GPS coordinates when the ballot is inserted into the ballot box. A reader 200 detects the RFID tag 100 as the RFID tag 100 enters the ballot box and records the time value and/or location value onto the RFID tag 100.

Upon arrival at the counting center, the reader scans each RFID tag embedded in the ballots and identifies any RFID tags containing values that fall outside a predefined valid range. Using this method, invalid ballots may be classified based on the recorded RFID data.

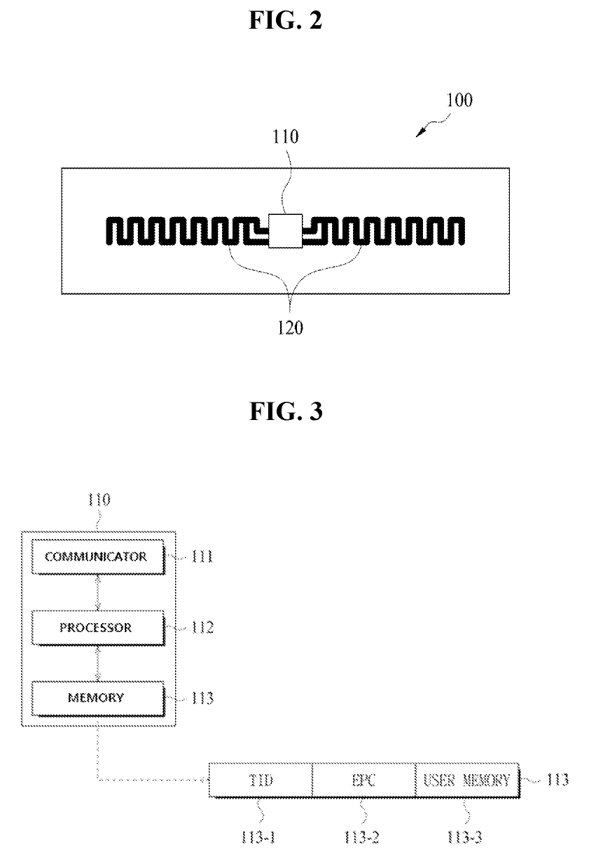

FIG. 2 is a block diagram of an RFID tag, and FIG. 3 is a block diagram of the memory structure of an RFID tag.

The RFID tag 100 includes a module 110 and an antenna 120. The module 110 consists of a communicator 111, a processor 112, and memory 113. The communicator 111 encodes and decodes RF signals transmitted and received via the antenna 120. The RFID tag 100 may receive RF signals from the reader and processes them accordingly. The RFID tag 100 harvests electromagnetic energy from the RF signal transmitted by the reader, using an antenna 120 and a rectifier circuit. This energy is stored in a capacitor and converted into operating power for the tag module 110. The demodulator within the module 110 extracts data from the received RF signal and interprets the reader's request, which may involve reading or writing data. The module 110 verifies whether a command received from the reader is authorized and generates an appropriate response signal. Using modulation techniques, the module 110 reflects the collected RF signal to transmit response signals back to the reader. The communicator 111 utilizes backscattering to reflect RF signals containing response data. The processor 112 interprets the reader’s request signal and generates a response signal containing the requested data.

The memory 113 consists of: TID 113-1, EPC 113-2, and User Memory 113-3.

TID 113-1 may be a read-only area storing the RFID tag's unique identifier, which includes manufacturer ID, product model ID, and serial number.

EPC 113-2 may be a writable section used to store identification data, typically 96-bit or 128-bit in size. The EPC 113-2 may contain a header, manager code, object class, and serial number. The EPC 113-2 may also store randomly generated values.

User memory 113-3 may be a data storage section where users may record or modify information. User memory 113-3 may be of variable size and configured with read and/or write permissions. According to embodiments of the present disclosure, Access to user memory 113-3 may be restricted using an encryption-based access control mechanism.

According to embodiments of the present disclosure, the RFID tag 100 embedded in the ballot contains a predefined value in the TID 113-1, which distinguishes it from other RFID tags. If an RFID tag 100 does not contain the predefined TID value, the ballot of the RFID tag 110 may be classified as invalid.

User memory 113-3 may be set to be accessed only through a specified password.

According to embodiments of the present disclosure, a set value can be stored in the TID 113-1. A value corresponding to a ballot, which is not stored in other RFID tags, can be stored in the TID (113-1) of the RFID tag 100 embedded in the ballot. An RFID tag 100 in which a set value is not stored in the TID 113-1 can be detected, and a ballot in which such an RFID tag 100 is embedded can be classified as an invalid ballot. The reader 200 can transmit an RF signal to the RFID tag 100 embedded in the ballot and receive a response signal including the TID 113-1 of the RFID tag 100.

According to embodiments of the present disclosure, a reader 200 equipped in a ballot box can record a time value, a location value, etc., in an RFID tag 100 of a ballot inserted into the ballot box. The time value to be recorded may be a time value at the time of insertion into the ballot box. The location value to be recorded may be a location value at the time of insertion into the ballot box. The time value or location value to be recorded may be a value measured by the reader 200. For example, the time value may be a time value acquired by the reader 200. The location value may be a location value acquired by the reader 200. The location value may be acquired by a GPS sensor of the reader 200. In another embodiment, the reader 200 may generate a combination value combining at least one of the time value, the location value, and the TID, and record the combination value in the memory of the RFID tag 100. These combination values can be recorded in the EPC 113-2 or the user memory 113-3. These combination values can be values generated using a random number generator or a specially developed algorithm.

The time value and/or location value may be recorded in the EPC 113-2 or user memory 113-3 of the RFID tag 100. The reader 200 may transmit a request signal for writing the time value or location value to the RFID tag 100. The reader 200 may release the write permission of the RFID tag 100 using pre-stored security-related information, and then record the time value and/or location value in the EPC 113-2 or user memory 113-3 of the RFID tag 100.

When the ballot box is opened and the votes are counted, the location value and time value of the ballot may be read from the RFID tag 100 of the ballot to determine whether the ballot is invalid.

The processor 112 may generate response signals based on requests received from the reader 200. The processor 112 may transmit these responses via the communicator 111.

The antenna 120 of the RFID tag 100 may transmit and receive RF signals, collect energy, and modulate data for communication. The antenna 120 of the RFID tag 100 may be designed to transmit and receive signals of a predetermined frequency. In order to be embedded in a ballot, the antenna 120 of the RFID tag 100 may be printed on paper using conductive ink. The antenna 120 of the RFID tag 100 may be printed on a film substrate using conductive ink.

The antenna 120 may be one of a coil-shaped antenna, an inductance coil-shaped antenna, a dipole, or a patch-shaped antenna. The antenna 120 may be adopted in a different form depending on the frequency of the signal to be transmitted and received.

The RFID tag 100 according to the embodiments of the present disclosure may be identified from a tag having another TID 113-1 recorded by having a set value recorded in the TID 113-1.

According to embodiments of the present disclosure, an RFID tag 100 may be identified from a tag with an invalid location value or an invalid time value by recording the location value and/or time value at the time of entry into a ballot box.

The RFID tag 100 according to embodiments of the present disclosure may record a predetermined value in the memory 113 in response to a request signal transmitted from a reader 200 of a ballot box.

Whether a ballot with an RFID tag 100 is valid or invalid may be determined through the value recorded in the RFID tag 100. Since the memory 113 of the RFID tag 100 may be accessed through a predetermined password, a read or write action may be executed on the memory 113 of the RFID tag 100 by a reader 200 in which data related to access rights is stored.

In the above embodiment, writing data to an RFID tag or reading data from an RFID tag may only be done by a reader 200 with predetermined authority. The reader 200 may be a device in which a password Write password, Access password for accessing an RFID tag is set.

In summary, RFID-enabled ballots enable secure and efficient vote validation by leveraging real-time data recording and verification, reducing the risk of unauthorized or fraudulent ballot entries.

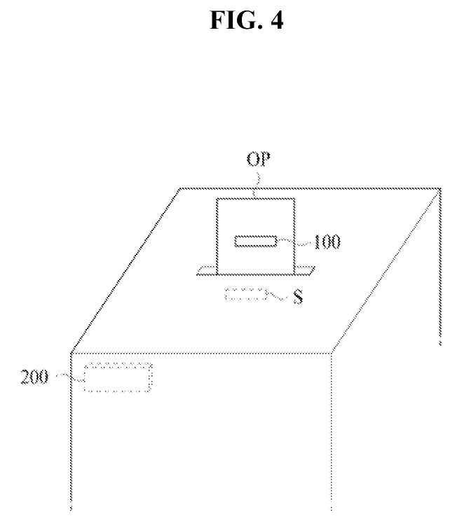

FIG. 4 illustrates the process in which an RFID-tagged ballot is inserted into a ballot box.

According to embodiments of the present disclosure, the insertion of a ballot OP with an embedded RFID tag 100 into a ballot box may be detected through a sensor S at the insertion port of the ballot box. The sensor S installed at the insertion port may be a proximity sensor.

When the sensor S at the insertion port of the ballot box recognizes the ballot OP, the reader 200 may transmit a request signal to record a time value and/or a location value with the RFID tag 100 embedded in the ballot OP.

The RFID tag 100 may receive a request signal through the antenna 120 and decode the request signal received through the module 110 to record a time value and/or a location value in the memory 113. The time value and/or the location value may be recorded in the EPC 113-2 or the user memory 113-3 in the memory 113. The RFID tag 100 may check whether the target memory block included in the request signal is in a write-locked state(write-protected state), and if so, may transmit an authentication request signal to the reader 200. Before recording the time value and/or the location value in the memory 113, the RFID tag 100 may send a signal to the reader 200 requesting a preset password “Write Password”.

The RFID tag 100 may process a signal from the reader 200 to record a time value and/or a location value if the password “Write Password” from the reader 200 matches the preset information. After such write permission is granted, the reader 200 may record a predetermined data in the RFID tag 100.

In an additional embodiment, the RFID tag 100 may execute a write verification process Write verification to check whether the write requested by the reader 200 is correctly recorded. In addition, the reader 200 may set the corresponding memory block to a write-locked state(write-protected state) after recording the time value and/or the location value in the RFID tag 100. As the write-locked state(write-protected state) is set in this way, when the time value and/or the location value are recorded in the RFID tag 100, these values may not be modified.

According to embodiments of the present disclosure, an RFID tag 100 embedded in a ballot that has entered a ballot box may store a time value and/or a location value at the time of entry according to a request signal of a reader 200. A data block in which the time value and/or a location value is stored in the RFID tag 100 may be prevented from being changed to a write-locked state(write-protected state) by the reader 200 and thus from being changed to a different data value. A ballot that is marked by a voter and inserted into a ballot box may have the time value and/or a location value recorded in the RFID tag 100. An RFID tag 100 embedded in a ballot may store a time value and/or a location value at the time of insertion into the ballot box.

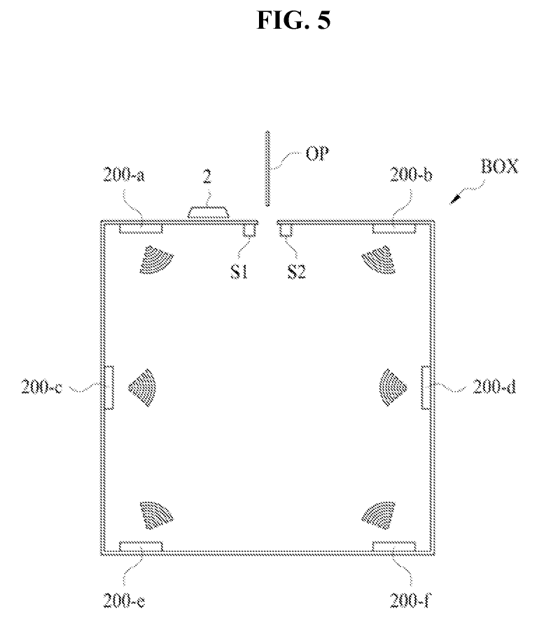

FIG. 5 is an exemplary drawing of a ballot box BOX according to embodiments of the present disclosure.

The ballot box BOX may include multiple readers 200-a, 200-b, 200-c, 200-d, 200-e, 200-f and sensors S1, S2 to identify the ballot.

The sensor S1, S2 of the ballot box BOX may detect the ballot OP.

Among the readers 200-a, 200-b, 200-c, 200-d, 200-e, 200-f, one reader 200-a may communicate with the RFID tag of the ballot OP entering a slot. The reader 200-a may record a time value, a location value, or a combination value in the EPC or user memory of the RFID tag. The combination value may be a value generated based on at least one of the time value, the location value, and the TID.

The readers 200-b, 200-c, 200-d, 200-e, 200-f may communicate with the RFID tags of the ballots loaded in the ballot box. The readers 200-b, 200-c, 200-d, 200-e, 200-f may communicate with the RFID tags to identify the presence of a ballot having an invalid range of time values, location values, and combination values.

Readers 200-b, 200-c, 200-d, 200-e, 200-f may scan RFID tags loaded in ballot boxes at regular intervals to count the number of ballots loaded in the ballot boxes at each point in time. In this way, the number of ballots at each point in time may be generated as time series data.

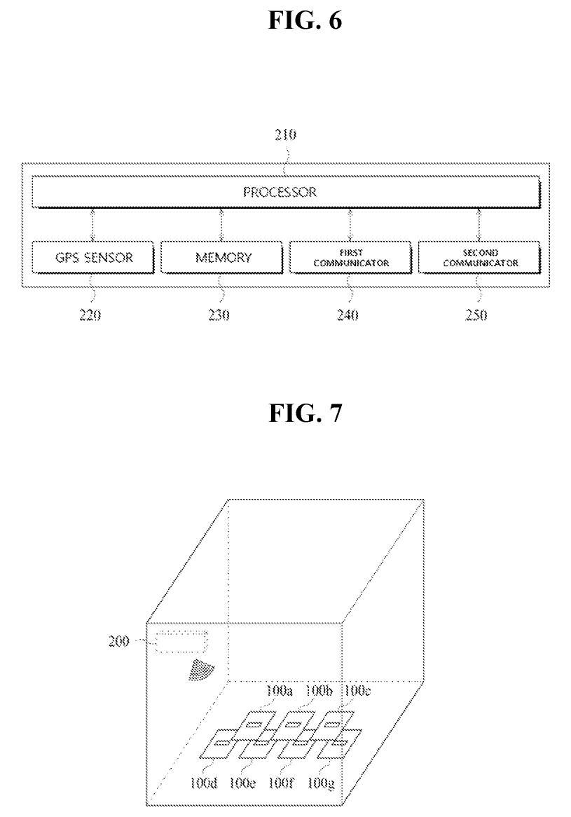

FIG. 6 is a block diagram of a reader 200 according to embodiments of the present disclosure.

The reader 200 may include a processor 210, a GPS sensor 220, a memory 230, a first communicator 240, and a second communicator 250.

The processor 210 may control a process of communicating with an RFID tag 100 embedded in a ballot through a first communicator 240. When the processor 210 detects a ballot input signal from a sensor installed in the input port, the processor 210 may transmit a request signal to record a time value and/or a location value in a predetermined data block to the RFID tag 100. The processor 210 may obtain a current location value through a GPS sensor 220. The processor 210 may transmit a request signal to record the time value and/or the location value in the EPC or user memory of the tag. The processor 210 may request a password for write permission Write Password from the RFID tag 100. In response to a signal requesting a password Write Password, the processor 210 may transmit a password stored in advance in the memory 230 to the RFID tag 100 to release the write permission. After recording the time value and/or location value in the RFID tag 100, the processor 210 may additionally transmit a signal to the RFID tag 100 to set the predetermined data block to a write-locked state(write-protected state).

The processor 210 may recognize each of the RFID tags present in the ballot box and obtain the time value and/or location value of each of the RFID tags. The processor 210 may transmit a signal requesting data stored in a predetermined data block to the RFID tag 100. The processor 210 may receive a modulation signal from the RFID tag 100. The processor 210 may transmit a signal including a command supported by the RFID tag e.g., Read Memory, a memory address to be read, or data block information.

The processor 210 may receive a signal requesting a password Access Password from the RFID tag 100 and generate and transmit a response signal thereto. The processor 210 may transmit a preset password stored in the memory 230 to the RFID tag 100.

The processor 210 may encrypt and transmit data transmitted to the RFID tag 100. For example, the processor may encrypt and transmit the time value to be recorded in the RFID tag 100, the location value, the password for write permission requested by the RFID tag 100, the password for read permission Access Password, the address information where data is to be recorded, data block information, etc.

In another embodiment, the processor 210 may obtain the TID of the RFID tag 100. If the TID of the RFID tag 100 is different from a preset value, the processor 210 may process the ballot with the RFID tag 100 embedded therein as an invalid ballot.

The processor 210 may obtain a time value and/or a location value from a predetermined data block from the RFID tag 100. If the time value and/or the location value is outside the predefined valid range, the processor 210 may process the ballot with the RFID tag 100 embedded therein as an invalid ballot. Here, the predefined valid range may include a valid range for the location value and a valid range for the time value. The valid range for the location value may be determined by the location value set for the ballot. The valid range for the location value may be set to a range in which the distance value with respect to the location value set for the ballot is within a preset minimum distance, for example, 5 meters.

The valid range for the time value may be the range from the start value to the end value of the voting time and the range from the start value to the end value of the early voting time.

The processor 210 may determine whether the ballot is an invalid ballot by obtaining the TID value from the RFID tag if the ballot is a ballot from early voting. The processor 210 may determine whether the ballot is an invalid ballot by obtaining the time value from the RFID tag if the TID value of the ballot is valid.

The processor 210 may determine whether the ballot is invalid by obtaining a TID value from an RFID tag if the ballot is a ballot by formal voting and whether the obtained TID value matches a pre-allocated TID value. The processor 210 may determine whether the ballot is invalid by obtaining a location value and/or a time value from an RFID tag if the TID value of the ballot is valid and whether the obtained location value and/or time value are within a preset validity range.

The processor 210 may randomly communicate with an RFID tag among the RFID tags in the ballot box. The processor 210 may obtain at least one of a value, a location value, and a time value stored in the TID through communication with the RFID tag 100 to determine whether the ballot of the RFID tag 100 is an invalid ballot. The processor 210 may scan each of the ballots in the ballot box to obtain the time value and/or the location value of the ballot, and determine whether each of the ballots is an invalid ballot based on the time value and/or the location value.

The first communicator 240 is a module that communicates with an RFID tag 100, and may transmit a modulation signal to the RFID tag 100 and receive an RF signal from the RFID tag 100.

The second communicator 250 is a module that communicates with an external electronic device and may enable short-distance communication such as Wi-Fi or Bluetooth and/or long-distance communication such as mobile communication.

FIG. 7 is a drawing illustrating a method of communicating with ballots loaded in a ballot box.

As shown in FIG. 7, a plurality of ballots 100a, 100b, 100c, 100d, 100e, 100f, 100g may be loaded into the ballot box.

The reader 200 may randomly communicate with an RFID tag among a plurality of ballots 100a, 100b, 100c, 100d, 100e, 100f, 100g in the ballot box. The reader 200 may obtain at least one of the values, location values, and time values stored in the TID through communication with the RFID tag 100 to determine whether the ballot of the RFID tag 100 is an invalid ballot.

The reader 200 scans each of the ballots 100a, 100b, 100c, 100d, 100e, 100f, 100g in the ballot box to obtain the time value and/or location value of the ballot, and may determine whether each of the ballots 100a, 100b, 100c, 100d, 100e, 100f, 100g is an invalid vote based on the time value and/or location value.

When the reader 200 detects one or more invalid ballots among the ballots 100a, 100b, 100c, 100d, 100e, 100f, 100g, the reader 200 may generate invalid ballot detection data and transmit the data to an external electronic device through the second communicator 250.

The reader 200 may transmit the time value at the time the ballot enters the slot to the external electronic device through the second communicator 250. The reader 200 may record the time value at the time the ballot enters the slot in the memory 230 and transmit data including the recorded multiple time values to the external electronic device through the second communicator 250. The data including the time values transmitted to the external electronic device in this way may be used to determine whether the ballot is an invalid ballot.

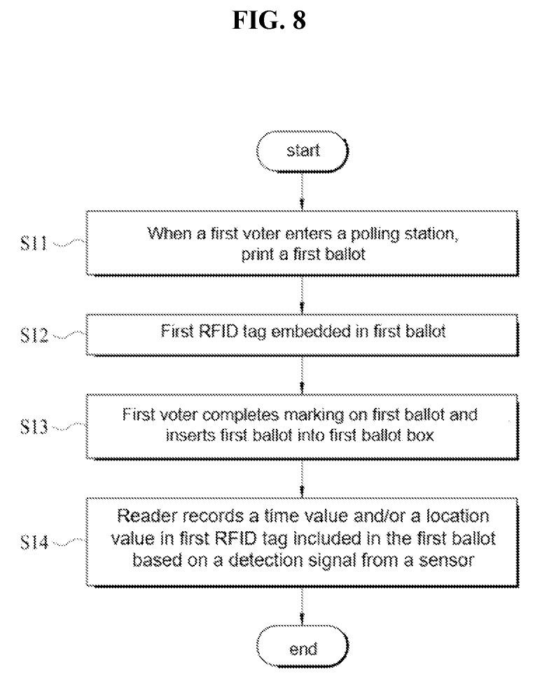

FIG. 8 is a flowchart of a process of recording data in an RFID tag included in a ballot according to embodiments of the present disclosure.

In S11, when a first voter enters a polling station, an election commissioner may verify the first voter's ID and print a first ballot corresponding to the first voter's address. At this time, the first ballot may further pass through a device that prints a first RFID tag so that the first RFID tag is embedded and printed S12. The first RFID tag embedded in the first ballot may not be visible to the naked eye. The location where the first RFID tag is included may be a random location within the first ballot. In an optional embodiment, a procedure for verifying whether the first RFID tag embedded in the ballot operates normally may be included when printing the first ballot. A separate device for measuring whether the first RFID tag operates normally may be further provided.

In S13, the first voter completes marking on the first ballot and inserts the first ballot into the first ballot box.

In S14, a sensor detects that a first ballot is inserted into a first ballot box, and the reader 200 may record a time value and/or a location value in the first RFID tag included in the first ballot based on a detection signal from the sensor.

The reader 200 may transmit a request signal to record the time value and/or the location value in a predetermined memory block to the RFID tag 100. The reader 200 may obtain the current location value through the GPS sensor 220. The reader 200 may transmit a request signal to record the time value and/or the location value in the EPC or user memory of the tag. The reader 200 may request a password for write permission Write Password from the RFID tag 100. In response to a signal requesting a password Write Password, the reader 200 may transmit a password stored in advance in the memory 230 to the RFID tag 100 to release the write permission. After recording the time value and/or location value in the RFID tag 100, the reader 200 may additionally transmit a signal to the RFID tag 100 to set the corresponding memory block to a write-locked state(write-protected state).

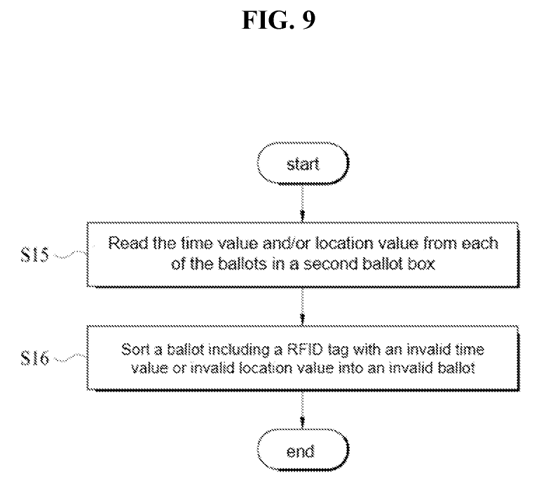

FIG. 9 is a flow chart of a method for classifying invalid ballots according to embodiments of the present disclosure.

When voting is completed, the ballot box is moved to a counting station. As the ballot box moves, additional ballots may be added to the ballot box or there may be an accident in which ballots in the ballot box fall out.

According to embodiments of the present disclosure, the time value and/or location value that should be recorded when the ballot box is additionally added is not recorded. In addition, since the ballot illegally added to the ballot box includes a commercially available RFID tag, a TID value other than the TID set for the election may be recorded.

In S15, the reader 200 may obtain the time value and/or location value from each of the ballots present in a second ballot box that arrived at the counting station. The reader 200 may obtain the time value and/or location value from each of the RFID tags included in the ballots. In another embodiment, the reader 200 may obtain a combination value from each of the RFID tags. The combination value may be a value generated based on at least one of a time value, a location value, and a TID.

The RFID tag 100 may modulate a signal including a time value and/or a location value stored by a request signal from the reader 200 and transmit a signal including the time value and/or the location value to the reader 200. The request signal for read permission may include a command supported by the RFID tag e.g., Read Memory, a memory address to be read, or data block information.

The RFID tag 100 may transmit a signal requesting a password Access Password before the reader 200 processes the request signal. At this time, the password may be 32 bits or 64 bits. In response to the requested signal, the reader 200 transmits a signal including a password, and the RFID tag 100 receives the signal, determines whether the password included in the signal matches, and if so, reads data from the corresponding address or data block. In an optional embodiment, the RFID tag 100 may encrypt and transmit the requested data.

In S16, the reader 200 may sort a ballot including an RFID tag with an invalid time value or location value recorded as an invalid ballot.

The reader 200 may obtain a time value and/or a location value from a predetermined data block from the RFID tag 100. If the time value and/or the location value are out of a predefined valid range, the reader 200 may process the ballot including the RFID tag 100 as an invalid ballot. Here, the predefined valid range may include a valid range for the location value and a valid range for the time value. The valid range for the location value may be determined by the location value set for the ballot. The valid range for the location value may be set to a range where the distance value from the location value set for the ballot is within a preset minimum distance, for example, 5 meters.

The valid range for the time value may be a range from the start value to the end value of the voting time and a range from the start value to the end value of the early voting time.

If the ballot is a ballot by early voting, the reader 200 may obtain a TID value from the RFID tag to determine whether the ballot is invalid. If the TID value of the ballot is valid, the reader 200 may obtain a time value from the RFID tag to determine whether the ballot is invalid.

If the ballot is a ballot by formal voting, the reader 200 may obtain a TID value from the RFID tag to determine whether the ballot is invalid. The reader 200 may determine whether the ballot is invalid by obtaining the location value and/or time value from the RFID tag if the TID value of the ballot is valid.

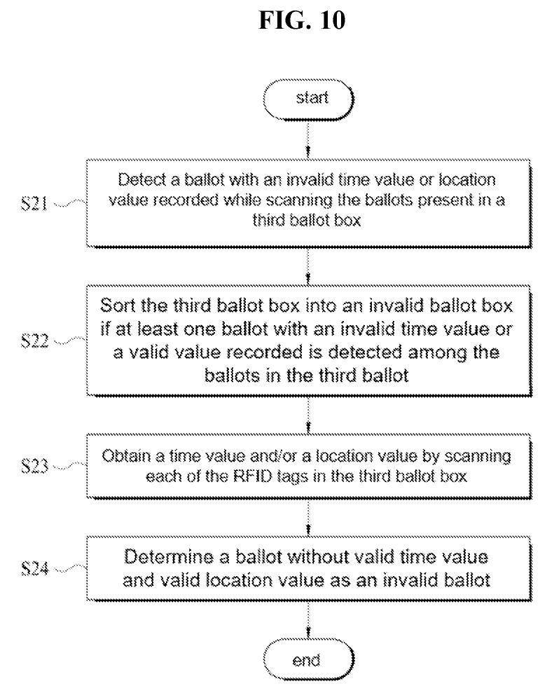

FIG. 10 is a flowchart of another method for classifying invalid ballots according to embodiments of the present disclosure.

In S21, the reader 200 may detect a ballot with an invalid time value or location value recorded while scanning the ballots present in a third ballot box.

In S22, the reader 200 may sort the third ballot box into an invalid ballot box if at least one ballot with an invalid time value or a valid value recorded is detected among the ballots present in the third ballot box. The third ballot box with an invalid ballot may be sorted into an invalid ballot box.

In S23, the reader 200 may obtain a time value and/or a location value by scanning each of the RFID tags included in the ballots present in the third ballot box. The reader 200 may obtain recorded data by scanning all ballots present in an invalid ballot box. The reader 200 may skip the process of scanning other ballots for ballot boxes that are not invalid ballot boxes.

In S24, the reader 200 may determine an invalid ballot by determining whether a time value obtained from an RFID tag is outside a predefined valid range. The reader 200 may determine an invalid ballot by determining whether a location value obtained from an RFID tag is outside a predefined valid range.

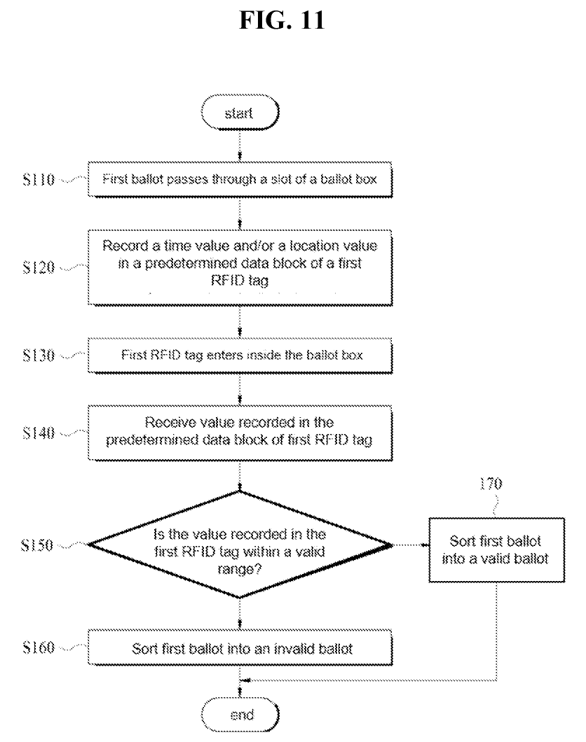

FIG. 11 is a flow chart of a method for determining whether a ballot is invalid according to embodiments of the present disclosure.

In S110, a first ballot may pass through a slot of a ballot box. A sensor attached to the ballot box may detect the first ballot that has entered the slot.

In S120, a reader of the ballot box may record a time value and/or a location value in a first RFID tag embedded in the first ballot. In another embodiment, the reader may generate and transmit a request signal for recording a time value, a location value, or a combination value in a predetermined data block of the first RFID tag.

In another embodiment, the reader may transmit a request signal to write data only in an RFID tag 100 where data has not yet been written in a predetermined data block. Since a ballot preloaded in a ballot box already has data such as a time value and a location value recorded in a predetermined data block, the reader may record data in an RFID tag where data has not been recorded in a predetermined data block.

The reader 200 may transmit a request signal to write a time value or a location value to the RFID tag 100. The request signal may include data to be recorded and data block information to be recorded. The data to be recorded may be a time value, a location value, or a combination value. The combination value may be a value generated based on at least one of a time value, a location value, and a TID. The reader 200 may release the write permission of the RFID tag 100 using pre-stored security-related information and then record the time value and/or the location value in the EPC 113-2 or the user memory 113-3 of the RFID tag 100. After recording the time value and/or the location value in the RFID tag 100, the reader 200 may set the corresponding memory block to a write-locked state(write-protected state). As the write-locked state(write-protected state) is established in this way, when the time value and/or the location value are recorded in the RFID tag 100, these values may not be modified.

In S130, the first RFID tag may be loaded inside the ballot box. When the voting time ends, the ballot box may be moved to the counting station.

Upon arrival at the counting station, the ballots in the ballot box are gathered in one place. In S140, the reader 200 may transmit a signal for reading the value recorded in the predetermined data block for each of the ballots in the ballot box, thereby receiving the value recorded in the predetermined data block. The reader 200 may receive a signal requesting a password Access Password from the first RFID tag, and generate and transmit a response signal with a password. The reader 200 may transmit a preset password stored in the memory to the first RFID tag 100, and only when the read approval is confirmed from the first RFID tag, may the value recorded in the predetermined data block be read.

In S150, the reader may determine whether the value recorded in the first RFID tag is within a valid range.

If the value recorded in the first RFID tag is a time value, the reader may determine whether the value is within a valid range set as a voting time.

If the value recorded in the first RFID tag is a location value, the reader may determine whether the value is within a valid range where a polling station is located.

If the value recorded in the first RFID tag is a combination value, the reader may decode the combination value according to a set decoding rule to obtain a time value, a location value, and a TID, and determine at least one of whether the time value is within a valid range set as a voting time, whether the location value is within a valid range where a polling station is located, and whether the TID matches a value pre-allocated for the corresponding election.

In S160, if the reader determines that the value recorded in the first RFID tag is out of the valid range, the first ballot to which the first RFID tag is attached may be sorted into an invalid ballot.

In S170, if the value recorded in the first RFID tag is within the valid range, the reader may sort the first ballot to which the first RFID tag is attached into a valid ballot.

According to embodiments of the present disclosure, the reader may determine whether the ballot is an invalid ballot using the data recorded upon entering the ballot box.

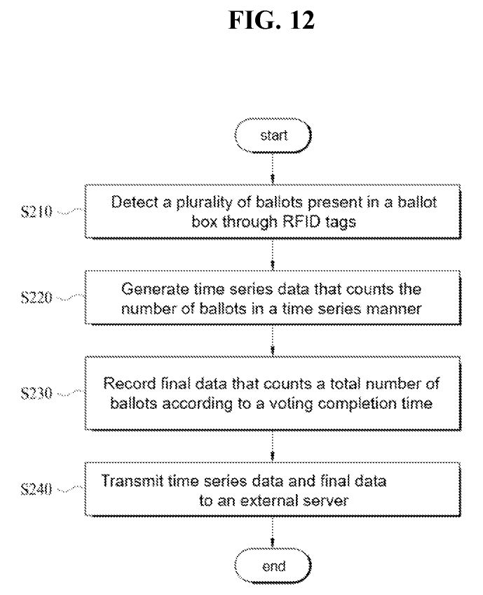

FIG. 12 is a flowchart of a method for generating time series data and final data according to embodiments of the present disclosure.

In S210, the reader 200 may detect a plurality of ballots present in a ballot box through RFID tags.

In S220, the reader 200 may generate time series data that counts the number of ballots present in the ballot box in a time series manner.

For example, the reader 200 may count the number of ballots present in the ballot box at each preset time period. Time series data including n1 ballots at a first time point, n2 ballots at a second time point, and n3 ballots at a third time point may be generated. Here, n1, n2, n3 may be natural numbers. If the number of ballots increased between the second time point and the third time point is greater than or equal to a preset minimum reference value, a procedure for verifying the number of ballots added between the second time point and the third time point may be performed. The procedure for verifying the number of ballots may obtain the number of people who voted at the polling station of the ballot box between the second time point and the third time point from the election management server, and compare whether the number of people who voted and the number of ballots match. If the number of people who voted and the number of ballots match or are nearly identical, the number of ballots added between the second time point and the third time point may be determined to be valid. Otherwise, the number of ballots added between the second time point and the third time point may be determined to be invalid. Here, near match means that the difference between the number of voters and the number of ballots is less than a preset value, for example, 3.

The reader 200 may scan each of the ballots present in the ballot box and count the number of ballots present in the ballot box. The reader may count the number of ballots by scanning the ballots at a predetermined time period.

In S230, the reader 200 may record final data that counts a total number of ballots present in the ballot box for each time according to a voting completion time. Here, the voting completion time may be based on a time registered in the election management server.

In S240, the reader 200 may transmit time series data and final data to an external server through the second communicator.

In another embodiment, the reader may transmit a time value of the time when the ballot enters the slot to an external electronic device through the second communicator, and the external electronic device may receive an entry event of the ballot and count the entry events to generate time series data. For example, the number of entry events received during a period from a first time to a second time may be recorded.

The external electronic device may determine whether an invalid ballot exists by comparing the first time series data generated through the entry event with the second time series data generated by counting in the reader.

For example, in the first time series data, if the number of entry events in the first time interval is 100, and in the second time series data, the number of ballots in the first time interval is 200, it may be determined that 100 ballots in the ballot box are invalid. In other words, the ballot box may be set as an invalid ballot box with invalid votes.

In addition, if an external electronic device finds a time zone where entry events received from a reader are excessively concentrated, it may generate an alarm message for this and record it separately. For example, if 50 or more ballots, which is more than the preset minimum value, are entered within 10 minutes, an alarm message may be generated and recorded separately.

The ballot box in this specification is made of non-metal, for example, fiberglass, reinforced plastic, so that the ballot box may fundamentally block external RF interference factors. In addition, in order to prevent strong electromagnetic waves from reaching the ballot box and completely damaging the RFID tags, the ballot box may be made of metal. The reader attached to the ballot box may record the location value in real time even after the voting time has ended, and monitor whether the ballot box has gone out of the designated area. If the location values recorded by the reader within the voting time and/or the location values after the voting time has ended are outside the predefined valid range, the ballot box may be set as an invalid ballot box.

As described above, the disclosure has been described with reference to the embodiment illustrated in the drawings, but this is merely an example. Those of ordinary skill in the art will fully understand that various modifications and other equivalent embodiments may be made from the embodiments. Therefore, the scope of the protection of the technology of the disclosure should be determined by the appended claims.

Specific technical descriptions in the embodiments are embodiments and do not limit the technical scope of the embodiments. In order to concisely and clearly describe the disclosure, descriptions of general techniques and configurations of the related art may be omitted. Also, connections or connection members of lines between elements illustrated in the drawings are examples of functional connections and/or physical or circuit connections, and may be represented by various alternative or additional functional connections, physical connections, or circuit connections in an actual device. In addition, unless specifically stated as "essential" or "importantly", an element may not be a necessary element for the application of the disclosure.

The term "above" or similar referring expressions used in the description and claims of the disclosure may refer to both the singular and plural expressions unless otherwise specified. Also, when a range is described in the embodiments, it means that embodiments to which individual values belonging to the range are applied are also included unless otherwise stated, it is the same as each individual value constituting the range is described in the detailed description of the disclosure. Moreover, steps or operations constituting the method according to the embodiments may be performed in an appropriate order, if the order is explicitly stated or unless otherwise stated. The embodiments are not necessarily limited according to the order of the description of the steps or operations. All examples or illustrative terms e.g., etc. in the embodiments are merely used to describe the embodiments in detail, and the scope of the embodiments is limited by the examples or illustrative terms unless limited by the claims. In addition, those of ordinary skill in the art will appreciate that various modifications, combinations, and changes may be made in accordance with design conditions and factors within the scope of the appended claims or equivalents thereof.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope included in the following claims.

OP: Ballot BOX: Ballot box

100: RFID tag 200: Reader

110: Module 120: Antenna

111: Communicator 112: Processor

113: Memory S, S1,S2: Sensor

What is claimed is:

1. A method for classifying invalid ballots using values recorded in an RFID tag embedded in a ballot, comprising:
receiving, by a reader, an insertion signal indicating that a first ballot is being inserted from a sensor located at a slot of a first ballot box;
transmitting, by the reader, a write request signal to store a predetermined value in a first RFID tag embedded in the first ballot;
identifying, by the reader, the first RFID tag upon arrival at a counting station and requesting and obtaining a value recorded in a predetermined data block of the first RFID tag; and
determining, by the reader, whether the recorded value is within a predefined valid range and, if the recorded value falls outside the valid range, classifying the first ballot with the first RFID tag as an invalid ballot.

2. The method of claim 1, wherein the transmitting the write request signal further comprises transmitting a write request signal to store at least one of a location value or a time value obtained via a GPS sensor in the data block.

3. The method of claim 1, wherein the transmitting the write request signal further comprises transmitting a signal to the first RFID tag to set the data block to a write-locked state after transmitting the write request signal.

4. The method of claim 1, wherein the requesting and obtaining the value comprises receiving a signal requesting an access password from the first RFID tag, and transmitting a pre-stored access password to the first RFID tag.

5. The method of claim 1, wherein the transmitting the write request signal comprises encrypting at least one of the location value or the time value obtained via a GPS sensor using a predetermined encryption method, and transmitting a write request signal to store the encrypted data in the data block.

6. The method of claim 1, further comprising separately storing the time value of the first ballot's insertion into an EPC or user memory, and generating and storing time-series data based on the number of ballots inserted within a predefined time interval.

7. A system for classifying invalid ballots using values recorded in an RFID tag embedded in a ballot, comprising:
a first communicator;
a second communicator;
a memory; and
a processor configured to:
receive an insertion signal indicating that a first ballot is being inserted from a sensor located at the slot of a first ballot box via the second communicator;
transmit a write request signal to store a predetermined value in a first RFID tag embedded in the first ballot;
identify the first RFID tag upon arrival at a counting station and request and obtain a value recorded in a data block of the first RFID tag;
determine whether the recorded value is within a predefined valid range, and
sort and record the first ballot with the first RFID tag as an invalid ballot, if the recorded value falls outside the valid range.

8. The system of claim 7, wherein the processor is further configured to transmit a write request signal to store at least one of a location value or a time value obtained via a GPS sensor in the data block.

9. The system of claim 7, wherein the processor is further configured to transmit a signal to the first RFID tag to set the data block to a write-locked state after transmitting the write request signal.

10. The system of claim 7, wherein the processor is further configured to receive a signal requesting an access password from the first RFID tag, and transmit a pre-stored access password to the first RFID tag.

11. The system of claim 7, wherein the processor is further configured to:
encrypt at least one of the location value or the time value obtained via a GPS sensor using a predetermined encryption method, and
transmit a write request signal to store the encrypted data in the data block.

12. The system of claim 7, wherein the processor is further configured to:
separately store the time value of the first ballot's insertion into an EPC or user memory, and
generate and store time-series data based on the number of ballots inserted within a predefined time interval.
